(19) United States
(12) Patent Application Publication
(10) Pub. No.: US 2011/0073605 A1
(43) Pub. Date: Mar. 31, 2011

(54) METHOD FOR MAKING SEED-CONTAINING MATERIALS FOR PACKAGING

(75) Inventors: Thomas Z. Fu, Naperville, IL (US); Matthew R. Cook, Hinsdale, IL (US)

(73) Assignee: LBP Manufacturing, Inc., Cicero, IL (US)

(21) Appl. No.: 12/890,223

(22) Filed: Sep. 24, 2010

Related U.S. Application Data
(60) Provisional application No. 61/246,779, filed on Sep. 29, 2009.

(51) Int. Cl. B65D 6/00; B32B 37/00; B32B 37/12; B32B 37/16

(52) U.S. Cl. 220/660; 156/60; 156/336; 156/210

(57) ABSTRACT

A method and machine are disclosed for manufacturing a seed-containing material for a food or beverage container or sleeve. The method is automated by a machine which has a conveyor and one or more work stations. During the process, seeds and a securing material, such as an adhesive, are added to the sheet material and the materials are optionally laminated. The method uses a sheet material that may be pre-printed and pre-cut with a blank of a container. The container may be any type of food and beverage container such as a cup, plate, container sleeve, clam shell, or tray. The sheet material is then conveyed for further processing including removal of the blanks from the sheet material and formation into the final product. After its intended end-use, the final product may be planted in a yard, garden, or flower pot to yield flowers or trees depending on the seeds imbedded inside.

### REFERENCE TO EARLIER FILED APPLICATION

This application claims the benefit under 35 U.S.C. §119(e) of U.S. Provisional Patent Application No. 61/246,779, filed Sep. 29, 2009, which is incorporated herein, in its entirety, by this reference.

### BACKGROUND

In our increasingly fast-paced society, individuals are forced to eat on the run. Often, they purchase food and drinks from convenience stores, restaurants, and cafés which offer take out options. Take out options are typically packaged in, for example, disposable cups, plates, trays, bags or clamshells. After an individual consumes her food she can quickly dispose of the food packaging in a trash receptacle.

Some papermakers add seeds to paper, for example, to provide attractive stationary with seeds. The seeds are commonly integrated into the paper product manually during papermaking. For example, they begin by creating paper pulp from paper fragments, functional additives, and water and add to that some seeds and liquid starch before molding and screening the paper.

### BRIEF SUMMARY

A method is disclosed for manufacturing a seed-containing material for a food or beverage container. The method is fully automated and uses roll or sheet materials such as single face material and fluted material. The container may be any type of food and beverage container such as a cup, plate, container sleeve, paper clam shell or tray. The method is automated by a machine or series of machines which convey the roll or sheet material to one or more work stations for processing into a seed-containing material. During the process, seeds and a securing material, such as an adhesive, are added to the roll or sheet material and the materials are laminated. The resulting seed-containing material is then conveyed for further processing including removal of the blanks from the sheet material and folding into the final product. The final product may be planted in a yard, garden, or flower pot to yield flowers, plants, or trees.

Other systems, methods, features and advantages of the disclosure will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a view of a first exemplary machine.

FIG. 2 is a flow chart demonstrating an exemplary process for making seed-containing materials for packaging.

FIG. 3 is a first arrangement of a seed-containing material.

FIG. 4 is a second arrangement of a seed-containing material.

FIG. 5 is a third arrangement of a seed-containing material.

FIG. 6 is a fourth arrangement of a seed-containing material.

FIG. 7 is a fifth arrangement of a seed-containing material.

FIG. 8 is a sixth arrangement of a seed-containing material.

FIG. 9 is a view of a second exemplary machine.

FIG. 10 is a view of an exemplary container made from the seed-containing material.

FIG. 11 is a view of a sleeve for the exemplary container of FIG. 10.

### DETAILED DESCRIPTION

Societies and the individuals that inhabit them are becoming increasingly interested in reducing the environmental impact of consumerism. Environmental issues dominate popular media, news, entertainment, and even political campaigns. In light of this, corporations and the service industry are searching for ways to demonstrate commitment to environmental leadership and to fulfill customer demand by offering environmentally friendly options. Corporations and the service industry also enjoy providing environmental awareness promotional items.

Food packaging may be made multi-purpose, such as food packaging that incorporates plant seeds. After consuming the contents of the food packaging, an individual may plant the packaging in their yard, garden, window box, flower pot, or otherwise. From that packaging, they may receive fresh flowers or other plants or trees. This form of packaging may be used as a standard packaging or as an attractive promotional item.

The multi-purpose food packaging may be recycled or thrown away. If the packaging ends up in a landfill, it provides an advantage of germinating and contributing to the breakdown of rubbish and the removal of the greenhouse gas and carbon dioxide from the atmosphere. Plants and trees are an effective means of removing carbon dioxide because they transfer carbon dioxide into carbohydrates and oxygen. The plants and trees may also improve the appearance of landfills.

Packaging materials integrating plant and tree seeds may be produced by the following machines and the methods at a rate, quality, and efficiency that may be superior to other paper making techniques. Because the seeds are exposed to moisture and heat during production, the types and sizes of the seeds may be chosen to take into consideration this moisture content and heat. In one embodiment, snapdragon flower seeds have been used and tested with favorable results, with roughly 2% to 30% of seeds planted germinated.

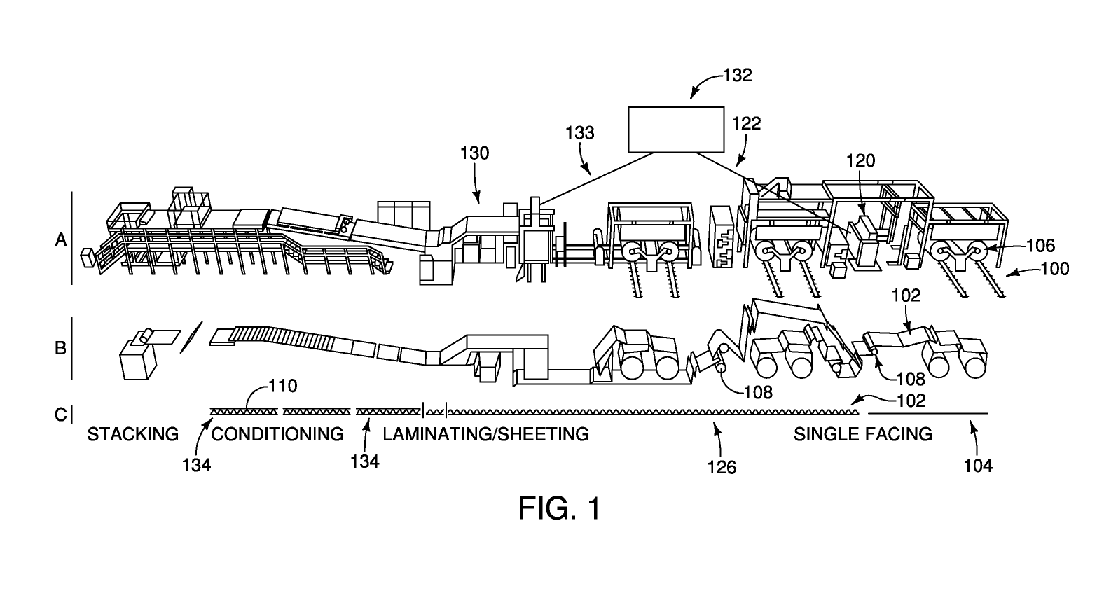

FIG. 1 illustrates a sheet-material-processing machine system 100 for carrying out a process for manufacturing packaging materials containing seeds. For example, but not limited to, the Asitrade microflute lamination machine can be used by this method to make seed-containing paper materials. The illustration provides three parallel views of a process: a view of the machinery A, a view of a manner in which the sheet material may travel through the machine system B, and a cross-section view of the resulting manufactured substrate material C. The machine system 100 may extend longitudinally over a considerable length and may include a number of work stations along its length. As displayed in FIG. 1, the sheet material being processed moves from right to left through the machine system 100.

The machine system 100 may use a first sheet material 102 which may be provided in bulk as a roll or web. Accordingly, the term “sheet” is not to be limited to the source of the material or how it is delivered, e.g., the sheet material may come off a roll and/or come in the form of a web as well as be delivered as individual sheets. The first sheet material 102 may be fed into the machine system 100 and through the various steps of the process by a wheel-based, belt-based, or other conveyance system. FIG. 1 illustrates the use of a wheel-based system. Alternatively or additionally, the machine system 100 may use sheet material which may be pre-printed. The final seed-containing substrate materials produced using machine 100 may be further converted to many packaging products, for example, but not limited to being die-cut with the pattern or blank of the particular packaging, for example, blanks of cups, containers, plates, clam shells, trays, bags or beverage container holders, among others.

The first sheet material 102 may be composed of a generally-flat material having some rigidity and being capable of being bent or scored to facilitate bending along determined lines. For example, but not limited to, the sheet material 102 may be selected from a variety of paper, such as Kraft paper, clay-coated news board, white-top liner, containerboards, SBS (solid bleached sulfate) boards or other materials. The material may be treated, such as to provide increased water or fluid resistance and may have printing on selected portions of the material. The first sheet material 102 may be made of recyclable materials or may be compostable, biodegradable, or a combination of these.

The first sheet material 102 may be conveyed by roller 108 to a first work station 120. The first work station 120 may be a corrugating station, which could be by-passed if material 102 does not need to be corrugated. For example, the first work station 120 may include a source of steam. The steam may be applied to the first sheet material 102. The first work station 120 may also include a corrugating roll. The corrugating roll may shape the first sheet material 102 into a series of waves or flutes. The first work station 120 may also include an applicator which may apply a securing or bonding material to a side of the first sheet material 102. For example, the applicator may be a metering roll applicator with a trough containing a securing material, such as an adhesive. The trough may be stationed near a corrugating roll such that the adhesive is applied to the tips of the waves or flutes generated by the corrugating roll. Additionally or alternatively, the securing material may be applied by spraying, brushing, or otherwise. For example, an applicator may apply the securing material by spraying it onto a side of the first sheeting material 102. The spray from the applicator may be constant or intermittent and may create broken lines, stripes, dots, or ellipses of securing material. Designs and patterns may be applied by moving the applicator or by moving the first sheet material 102 relative to the sprayer.

The securing material may be, for example, an adhesive, a thermal insulating material, or other materials or coatings, for example, those with securing properties. For example, the securing material may be a starch adhesive, or any other adhesives.

The securing material may be delivered to the applicator from a line 122, which may originate at a seed conditioning and preparation station 132. The securing material may be premixed with seeds at a seed conditioning and preparation station 132 before or during delivery to the applicator of the first work station 120.

The first sheet material 102 may be incorporated with a second sheet material 104, for example, by pressing the second sheet material 104 to the first sheet material 102. The second sheet material 104, which may be a liner, may be secured to the first sheet material 102 by the securing material resulting in a two-layer sheet material 126, such as single-face fluted sheeting as shown in FIG. 1, C. If the adhesive is a seed-containing adhesive, the two layer sheet material 126, e.g., single-face fluted sheeting, may contain a layer of seeds between the second sheet material 104, which may be a liner, and the first sheet material 102 which may be a fluted medium. Alternatively, the second sheet material 104 and the first sheet material 102 may not include a layer of seeds therebetween.

A seed-containing two layer sheet material 126, such as a single-face fluted sheeting, may exit the machine system 100 and go on to further processing (e.g., die cutting, printing, folding, etc.) into the desired final product.

Alternatively, the seed-containing or non-seed-containing two-layer sheet material 126, such as a single-face fluted sheeting, may be further processed by the machine system 100 as described below.

The sheet material, which may be seed-containing or non-seed-containing two-layer sheet material 126 may be conveyed to a second work station 130. The second workstation 130 may include an applicator which may apply a securing material, such as a seed-containing securing material, to a side of the two-layer sheeting 126, which may be single-face fluted sheeting. For example, the applicator may apply a securing material, such as a seed-containing securing material, to the second sheet material 104 side of the two layer sheeting 126, which may be the liner side of the two layer sheeting 126. Alternatively or additionally, the applicator may apply a securing material, such as a seed-containing securing material, to the first sheet material 102 side of the two layer sheeting 126. The securing material may be an adhesive, a coating material, a finishing material, or otherwise. For example, the securing material may be a cold set or a hot set adhesive, for example a hot-melt adhesive, starch-based adhesive, natural polymer adhesive, cellulose based adhesive, glue, hot melt glues, cold set glues, binder, polymeric binder, foams, and etc.

The securing material may be applied by spraying, brushing, or otherwise. For example, the applicator may be a trough containing a securing material. The trough may be stationed near the roll which feeds the paper into the second work station 130 such that the securing material is applied to the tips of the waves or flutes generated by the corrugating roll. As a second example, an applicator may apply the securing material by spraying it onto a side of the first sheeting material 102 the second sheeting material 104 or both. The spray from the applicator may be constant or intermittent and may create broken lines, stripes, dots, or ellipses of securing material. Designs and patterns may be applied by moving the applicator or by moving the first sheet material 102 relative to the sprayer. The securing material may be premixed with seeds at one or several separate seed conditioning and preparation station 132 before or during delivery to the applicator, for example, through a line 133.

The two-layer sheeting material 126 may be incorporated with a third sheet material 110, which may be a second liner, for example, by pressing the third sheet material 110 to the two layer sheeting 126 creating a three-layer seed-containing sheet material 134 also referred to as a single wall sheet material. Further processing may be performed to add another fluted sheet and another liner sheet, in that order, to the three-layer seed-containing material using additional securing material layers to optionally create a double wall seed-containing sheet material.

The third sheet material 110 may be composed of a generally-flat material having some rigidity and being capable of being bent or scored to facilitate bending along determined lines. For example, the third sheet material 110 may be single-face liner paper, for example but not limited to Kraft paper. The material may be treated, such as to provide increased water or fluid resistance and may have printing on selected portions of the material. Alternatively or additionally, the third sheet material 110 may be composed of corrugated cardboard, chipboard, SBS, metalized paper, plastic, polymer, fibers, composite, mixtures or combinations of the foregoing, and the like. The third sheet material 110 may be made of recyclable materials or may be compostable, biodegradable, or a combination of these.

The second work station 130 may be a laminator. The layers may be laminated which may improve the structural integrity and appearance of the resulting seed-containing packaging material. The temperature during the lamination process may be optimized to maintain seed integrity and improve germination fidelity.

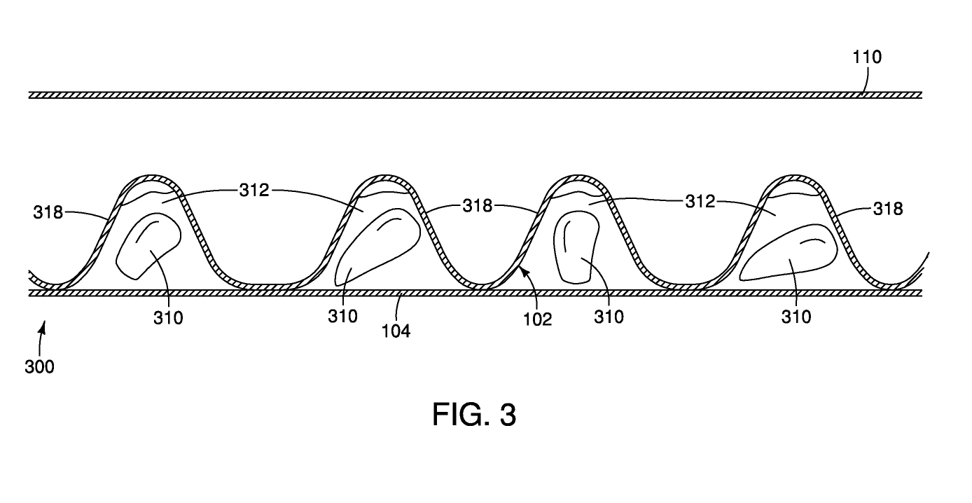

FIGS. 3-8 provide examples of greater detail of some possible arrangements of the layers of sheet material and layer of seeds. Other configurations are possible and envisioned. The final seed-containing packaging material may be conveyed to final processing such as sheeting the final seed-containing substrate, die cutting, removing the blanks from the sheet material, and folding the blanks into a final product.

As discussed above, securing material used in the process may be a seed-containing adhesive. Seeds may be added to the adhesive at a seed conditioning and preparation station 132, or at several of these kinds of stations. The seed-containing securing material may then be loaded into an applicator for application to the sheet material.

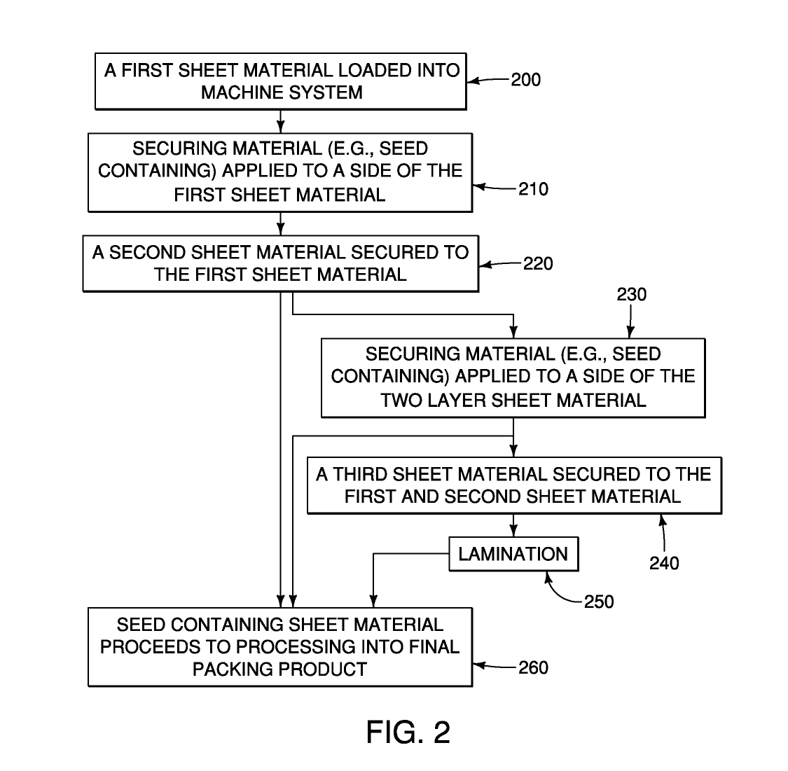

FIG. 2 is a flow chart which illustrates a possible sequence of events of the method. A first (sheet) material may be loaded into a machine system, at block 200. A securing material may be applied to a side of the first sheet material, at block 210. The securing material may include seeds. A second (sheet) material may be secured to the first sheet material, at block 220, which may create a two-layer sheet material. The two-layer sheet material may contain seeds and may exit the process to be processed (e.g., printed, die cut, removed from blanks, assembled), at block 260. Alternatively, a securing material may be applied to a side of the two-layer sheet material, at block 230. The securing material may contain seeds. The two-layer sheet material may contain seeds and may exit the process to be processed (e.g., printed, die cut, removed from blanks, assembled), at block 260. Alternatively, a third sheet material may be secured to the first and second sheet materials, at block 240. The sheet material, seeds, and securing material may be treated by a laminator which may secure the seeds to the sheet material, at block 250. The resulting seed-containing sheet material may exit the process to be processed (e.g., printed, die cut, removed from blanks, assembled), at block 260.

For example, the resulting sheet material may be further processed such as by application and subsequent removal of packaging blanks from the sheet material and assembly of the blanks into the final product, at block 260. The final product of the process (which may be, e.g., a cup, container holder, container sleeve, clamshell, tray, or otherwise) may be made of one or more layers of one or more of the aforementioned materials. Where multiple layers of material are used they may be joined, such as, but not limited to, being laminated, glued, or otherwise fastened together for increased strength.

FIG. 3 illustrates one exemplary arrangement of seeds and sheet material. In this arrangement, the resulting seed-containing sheet material 300 includes a first sheet material 102, a second sheet material 104, and a third sheet material 110. The second sheet material 104 is a single wall flat material, the first sheet material 102 is a fluted material (e.g., E-flute or F-flute), and the third sheet material 110 is a single wall flat material, such as Kraft paper. In this example, seeds 310 may be secured between the first sheet material 102 and the second sheet material 104. During the process, the seeds 310, which are mixed into a securing material 312, may be applied to the flutes of the first sheet material 102 before the second sheet material 104 is adhered to the first sheet material, thus locating the seed-containing securing material 312 underneath the hills between flutes 318 of the fluted material 102. The securing material 312 may partially or completely fill the space between the flutes 318 of the fluted material 102. The third sheet material 110 may then be applied to the other side of the fluted, first sheet material 102 with a securing material that does or does not include seeds.

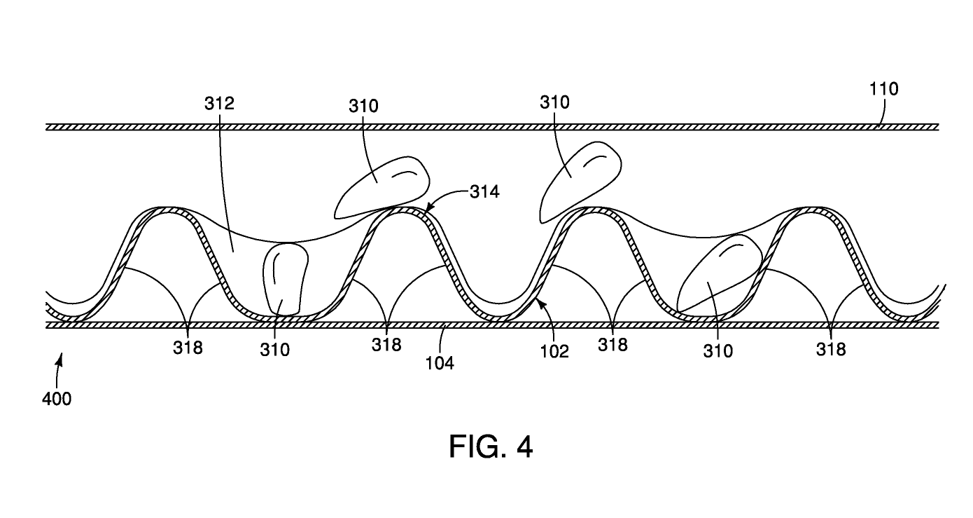

FIG. 4 illustrates a second exemplary arrangement of seeds and sheet material. In this arrangement, the resulting seed-containing sheet material 400 also includes the first sheet material 102, the second sheet material 104, and the third sheet material 110. The second sheet material 104 is a single wall flat material, the first sheet material 102 is a fluted material (e.g. E-flute or F-flute), and the third sheet material 110 is a single wall flat material, such as Kraft paper. In this example, arrangement of the seeds 310 is to secure between the first sheet material 102 and the third sheet material 110. During the process, the seeds 310, which are mixed into the securing material 312, may be applied to the flute tips 314, in the valley between the flutes 318, or both. The securing material 312 may closely coat the seeds 310 or, alternatively, the securing material 312 may completely fill the space between the first sheet material 102 and the third sheet material 110.

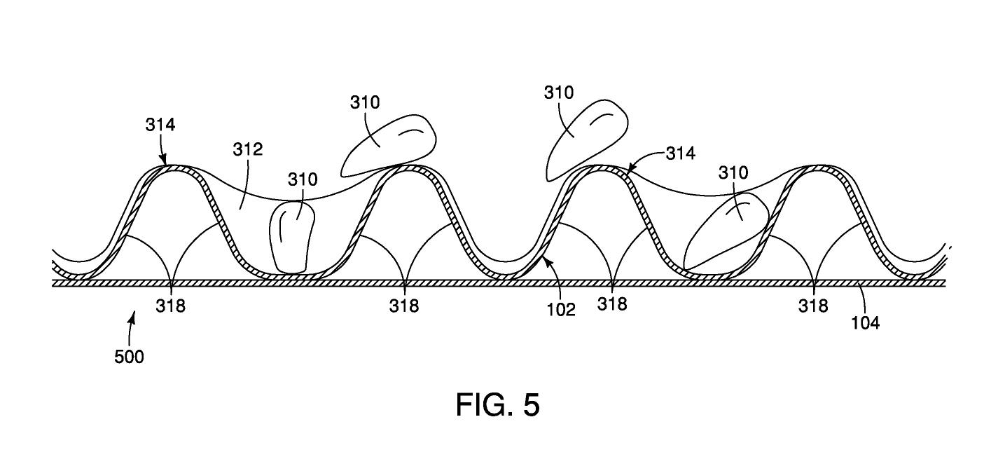

FIG. 5 illustrates a third exemplary arrangement of seeds and sheet material. In this arrangement, the resulting seed-containing sheet material 500 includes the first sheet material 102 and the second sheet material 104, creating a single-wall arrangement with the seeds secured to a side of the first sheet material 102. The second sheet material 104 is a single wall flat material such as Kraft paper and the first sheet material 102 is a fluted material (e.g., E-flute or F-flute). In this example, the seeds 310 are applied to a side of the first sheet material 102. During the process, the seeds 310, which are mixed into the securing material 312, may be applied to the flute tips 314, in the valley between the flutes 318, or both. The securing material 312 may closely coat the seeds or, alternatively, overfill the valley between the flutes 318 creating a smooth outer surface of securing material 312.

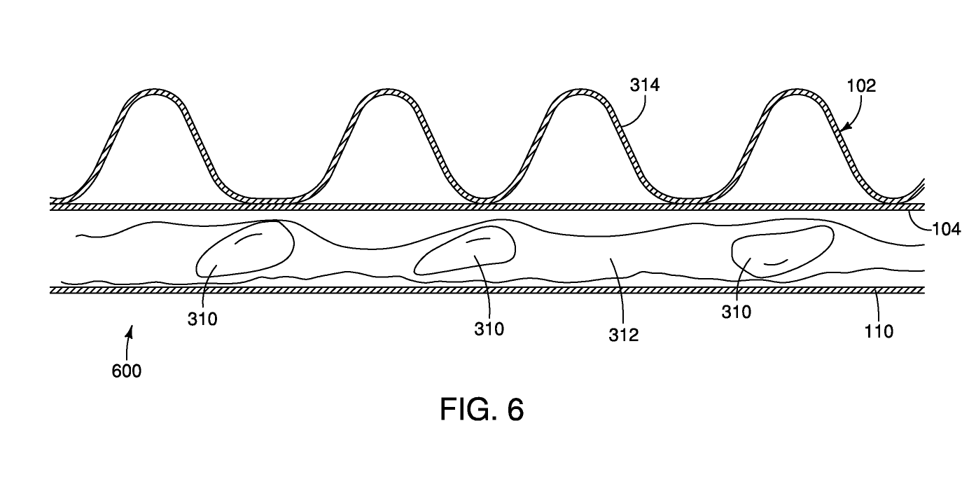

FIG. 6 illustrates a fourth exemplary arrangement of seeds 310 and sheet material. In this arrangement, the resulting seed-containing sheet material 600 includes a first sheet material 102, a second sheet material 104, and a third sheet material 110. The second sheet material 104 is a single wall flat material, the first sheet material 102 is a fluted material (e.g., E-flute or F-flute), and the third sheet material 110 is a single wall flat material, such as Kraft paper. In this example, the seeds are secured between the second sheet material 104 and the third sheet material 110, and the first sheet material 102 is located on a side of the second sheet material 104 opposite from the third sheet material 110. During the process, the seeds 310, which are mixed into the securing material 312, may be applied to the side of the second sheet material 104 that faces away from the first sheet material 102. The securing material 312 may closely coat the seeds or, alternatively, it may completely fill the space between the second sheet material 104 and the third sheet material 110.

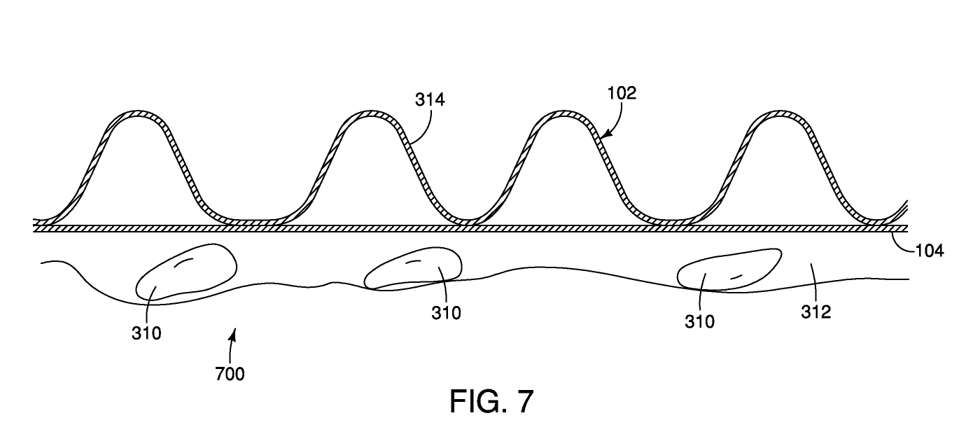

FIG. 7 illustrates a fifth exemplary arrangement of seeds 310 and sheet material. In this arrangement, the resulting seed-containing sheet material 700 includes a first sheet material 102 and a second sheet material 104, creating a single-face material with the seeds secured to a side of the first sheet material 102. The second sheet material 104 is a single wall flat material such as Kraft paper and the first sheet material 102 is a fluted material (e.g., E-flute or F-flute). In this example, the seeds 310 are applied to the side of the second sheet material 104 that faces away from the first sheet material 102. The securing material 312 may closely coat the seeds or, alternatively overfill the seeds 310 creating a smooth outer surface of securing material 312.

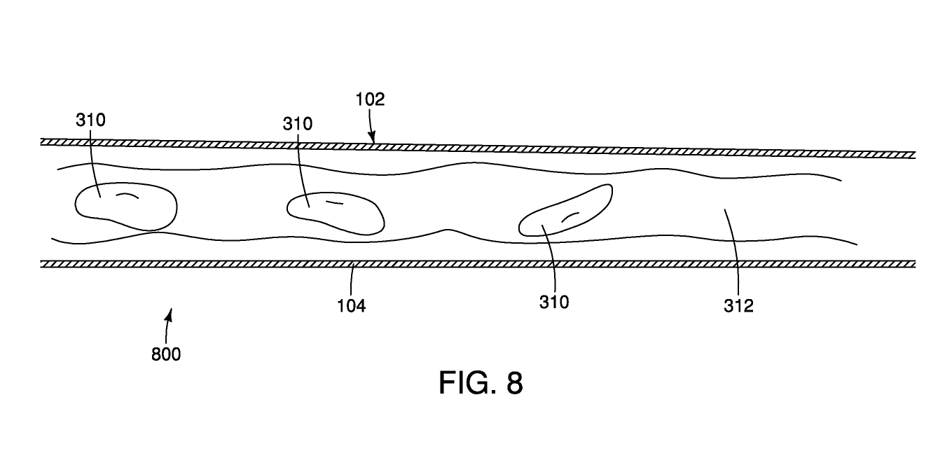

FIG. 8 illustrates a sixth exemplary arrangement of seeds 310 and sheet material. In this arrangement, the resulting seed-containing sheet material 800 includes a first sheet material 102, and a second sheet material 104. The first sheet material 102 is a single wall flat material and the second sheet material 104 is also a single wall flat material, such as Kraft paper. In this example, the seeds 310 are secured between the first sheet material 102 and the second sheet material 104. During the process, the seeds 310, which are mixed into the securing material 312, may be applied either to a side of the first sheet material 102 or a side of the second sheet material 104. The securing material 312 may closely coat the seeds or, alternatively, may completely fill the space between the first wall of the first sheet material 102 and the second wall of the second sheet material 104.

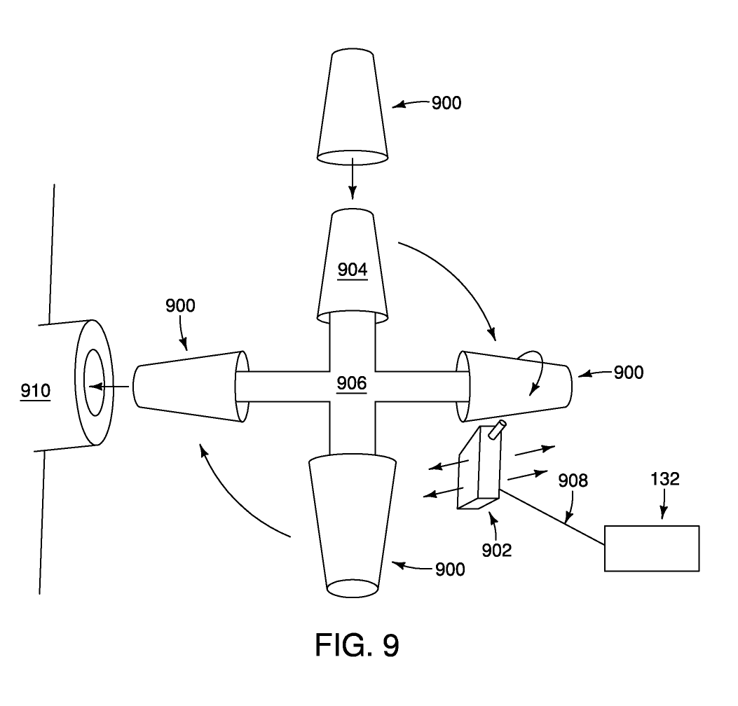

FIG. 9 illustrates a second exemplary method of making seed-containing consumer products. Seed-containing cups, tubs, bowls, and other items may be manufactured by applying a seed-containing securing material 312 to a preformed container 900. In this example, the method may be adapted to a container-wrapping machine. The seed-containing securing material 312 may be applied continuously or intermittently via an applicator 902 such as a nozzle, glue gun, or slot die applicator onto the outside of, e.g., a container 900 which may be secured to a mandrel 904. The pattern of seed-containing securing material 312 may be manipulated by movement of the container 900 relative to the applicator 902. For example, the mandrel 900 may be spun and/or moved up or down or in another direction to achieve a desired pattern, e.g., spiral, dotted, lined, and the like.

Alternatively or additionally, the applicator 902 may move relative to the container 900 to achieve a desired pattern. For example, mandrels 904 may be arranged on a rotating arm 906. A container 900 may be loaded onto the mandrel 904 manually or be fed by machine. The arm 906 may move the container 900 proximate to the applicator 902. The applicator 902 may apply patterns of seed-containing securing material 312 to the container 900 by moving relative to the container 900. The mandrel 904 may also move the container 900 relative to the applicator 902, such as by rotation. As an example, stripes may be applied to the cup by side-to-side movement of the applicator 902 combined with rotational movement of the mandrel 904. The spray from the applicator 902 may be constant or intermittent and may create broken lines, stripes, dots, or ellipses of foam. Swirls may be applied by constant spray from the applicator 902 combined with side movement and rotation of the mandrel 904.

The applicator 902 may be attached to a line 908 which may deliver the seed-containing securing material 312, for example, from a seed preparation and mixing station 132. After the seed-containing securing material 312 has been applied, the arm 906 may move the container 900 to a different position where the cup may be removed from the mandrel for further processing. For example, an integrated, double-wall container may be formed by inserting the container 800 into an outer wall. The outer wall may be preformed and located in a cavity 810 into which the container 900 may be inserted.

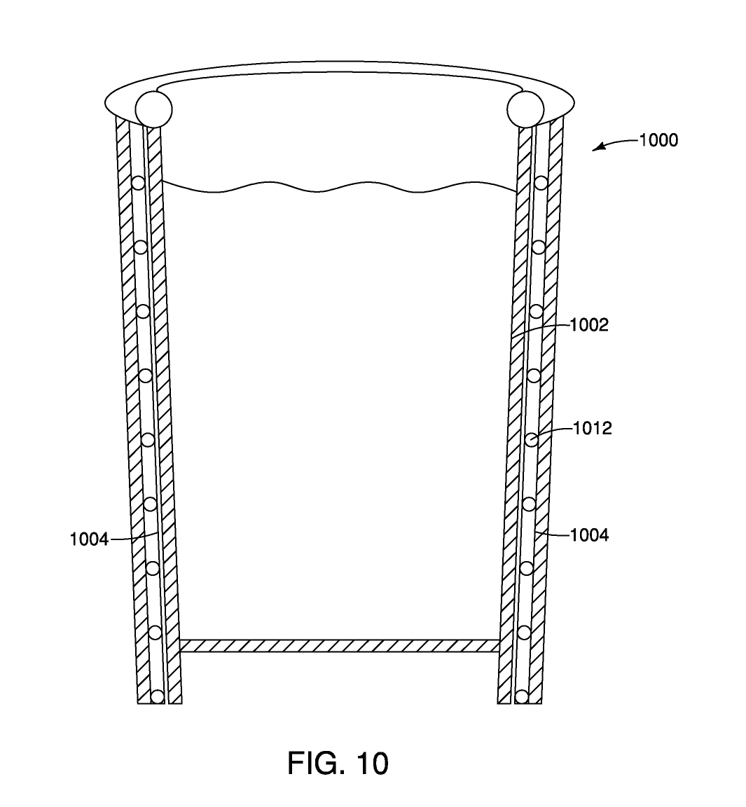

FIG. 10 illustrates a cross sectional view of an exemplary seed-containing container 1000. Although FIG. 10 illustrates a liquid container, it could be any container, such as a cup, soup tub, a pop corn tub, or otherwise. The seed-containing container 1000 may have an inner wall 1002 and an outer wall 1004. The inner wall 1002 of the container 1000 may be of a preformed container 900 such as in FIG. 9. There may be a layer of seed-containing securing material 1012 between the inner wall 1002 and the outer wall 1004.

Additionally or alternatively, the seed-containing securing material 1012 may be applied during the final processing steps, such as when blanks for cups, sleeves, clam shells, trays, are being folded into their final conformation or form.

After a final product, such as a container, cup, container sleeve, clamshell, or tray has been used, an end user may plant the item in a flower pot, in the yard, in a garden, or otherwise.

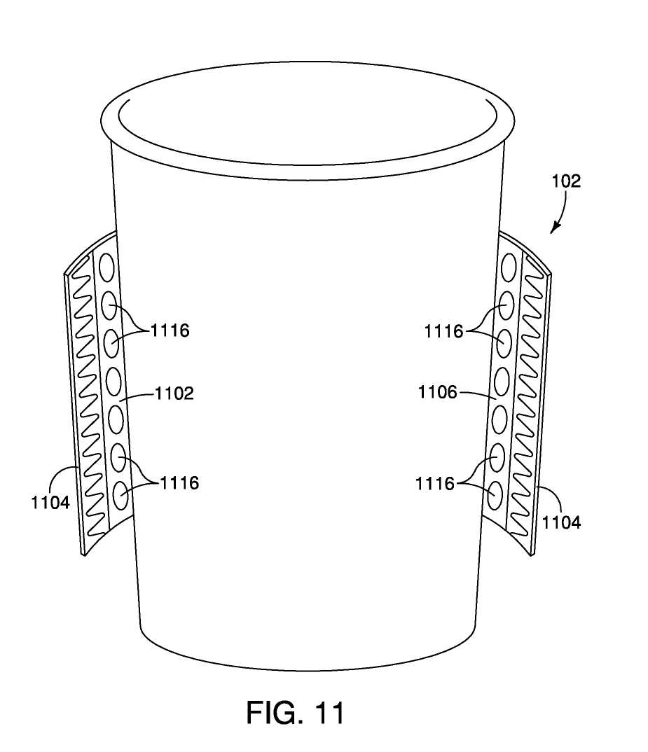

For instance, FIG. 11 illustrates a cross section of the outer wall 1104, such as a sleeve, assembled with the container 1000. This Figure is meant to be illustrative and not limiting. The cup may be replaced with any container, for example, a press-formed tray, a soup tub, or a bulk beverage container. The outer wall 1104 may have an inner face 1106 and an outer face 1104. An insulating material 1116 may be applied to the inner face 1106, the outer face 1104, and/or to a surface 1102 between the inner face 1106 and the outer face 1104, such as to an inner wall of the sleeve. The inner face 1106 and outer face 1104 do not necessarily contain a space 1102 therebetween.

The insulating material 1116 which may or may not contain seeds, such as an expandable material, may be applied to an inner face 1106 of the outer wall 1104 in an inactive form. The inactivated insulating material 1116 may be applied as a thin film that does not materially alter the thickness of the outer wall 104. Applying the insulating material 1116 to the inside of the outer wall 1104 may also maintain the printability of the outer face of the outer wall 1104.

The securing material 312 and the insulating material 1116, when used, may be largely free of fertilizers, pesticides, nitrogen fixing bacteria, spores, or other growth factors. This may decrease the cost of making the product and may also increase the safety of using the product in consumer products meant to be used with food items.

While various embodiments of the invention have been described, it will be apparent to those of ordinary skill in the art that many more embodiments and implementations are possible that are within the scope of the invention. For instance, steps of a method as displayed in the figures or reflected in the below claims do require a specific order of execution by the way they are presented, unless specified. The disclosed steps are listed as exemplary such that additional or different steps may be executed or the steps may be executed in a different order.

1. A method of manufacturing a seed-containing material for a food or beverage container, comprising:
passing a first sheet material into a sheet-material-processing machine system, the first sheet material having at least two sides;
applying a first securing material to a side of the first sheet material, the first securing material including seeds;
applying a second sheet material to a side of the first sheet material, resulting in a first final sheet material; and
processing the first final sheet material into a final product.

2. The method of claim 1, further comprising:
mixing the seeds and the first securing material at a preparation station of the machine system.

3. The method of claim 1, further comprising:
pre-mixing the seeds and the first securing material before loading the first securing material into the machine system.

4. The method of claim 1, where the second sheet material is applied to the side of the first sheet material to which is applied the first securing material.

5. The method of claim 1, further comprising:
applying a second securing material to an exposed side of the first sheet material or the second sheet material;
applying a third sheet material to the second securing material;
laminating the first sheet material, the second sheet material and the third sheet material, resulting in a second final sheet material; and
processing the second final sheet material into the final product.

6. The method of claim 5, where the second sheet material is a single-face corrugated paper board comprising fluting, and where the first securing material is applied on the side of the first sheet material to which the second sheet material is applied.

7. The method of claim 6, where the first securing material is an adhesive.

8. The method of claim 7, where the adhesive is a starch-based adhesive.

9. A method of manufacturing a seed-containing material for a food or beverage container, comprising:
passing a first sheet material into a machine system, the first sheet material having at least two sides;
corrugating the first sheet material;
applying a first securing material to a side of the first sheet material, the first securing material having mixed therein a plurality of seeds;
applying a second sheet material to the side of the first sheet material; and
processing the final sheet material into a final product.

10. The method of claim 9, where the first sheet material is a single-face corrugated paper.

11. The method of claim 10, further comprising:
applying a second securing material to an exposed side of the first sheet material or the second sheet material;
applying a third sheet material to the second and third sheet materials; and
laminating the first sheet material, the second sheet material and the third sheet material, resulting in the final sheet material.

12. The method of claim 9, where the securing material is a starch-based adhesive.

13. A method of manufacturing a seed-containing material for a food or beverage container, comprising:
passing a first sheet material into a machine system, the first sheet material having at least two sides;
corrugating the first sheet material;
applying a first securing material to a side of the first sheet material;
applying a second sheet material to the side of the first sheet material;
applying a second securing material to an exposed side of the first sheet material or the second sheet material;
adding seeds to one or more selected from the group consisting of the first and the second securing materials;
applying a third sheet material to the second securing material side of the first and second sheet materials;
laminating the first sheet material, the second sheet material and the third sheet material, resulting in a final sheet material; and
processing the final sheet material into a final product.

14. The method of claim 13, further comprising:
mixing seeds into the first or second securing material at a preparation station.

15. The method of claim 13, further comprising:
pre-mixing seeds and the first securing material before loading the first securing material into the machine system.

16. The method of claim 13, where the second sheet material is a single-face corrugated paper board, where the corrugated paper board comprises fluting.

17. The method of claim 13, where the first and third sheet materials comprise liners, the method further comprising:
applying a third securing material to one of the liners;
adhering a fourth, fluted sheet material to the third securing material;
applying a fourth securing material to the fourth, fluted sheet material;
adhering a fifth sheet material comprising a liner to the fourth, fluted sheet material; and
laminating the first through fifth sheet materials to create a double-wall sheet final product.

18. The method of claim 17, where the securing materials are starch-based adhesives.

19. A container formed from a sheeting comprising first and second sheet materials adhered to each other in a sheet-material-processing machine system, and a first securing material applied to either or both of the first and second sheet materials, the securing material having mixed therewith a plurality of seeds.

20. The container of claim 19, where the sheeting further comprises:
a second securing material applied to the first sheet material or the second sheet material; and
a third sheet material adhered to the corresponding first or the second sheet material.

21. The container of claim 20, where the second sheet material comprises a corrugated paper board having fluting, and where the first securing material is applied on the side of the first sheet material to which the second sheet material is applied.

22. The container of claim 20, where the container formed comprises one selected from the group consisting of a double wall cup, a single wall cup, a plate, a container sleeve, a clam shell, and a tray.

23. A container formed from a sheeting comprising:
first and second sheet materials adhered to each other along first sides thereof in a sheet-material-processing machine system;
a first securing material located between the first and second sheet materials;
a second securing material applied to the second side of the first or the second sheet materials; and
a third securing material applied to the second securing material;
where one or more selected from the group consisting of the first securing material and the second securing material contain seeds.

24. The container of claim 23, where the second sheet material comprises a corrugated paper board having fluting.

25. The container of claim 24, where the securing material is a starch-based adhesive.

26. The container of claim 24, where the container formed comprises one selected from the group consisting of a double wall cup, a plate, a container sleeve, a clam shell, a bag, and a tray.
